(19) United States
(12) Patent Application Publication
(10) Pub. No.: US 2012/0250664 A1
(43) Pub. Date: Oct. 4, 2012

(54) Method to avoid collision in a synchronised wireless network

(76) Inventor: Xiaoyun Li, Shenzhen (CN)

(21) Appl. No.: 13/064,488

(22) Filed: Mar. 28, 2011

(51) Int. Cl. H04W 84/02

(52) U.S. Cl. 370/338

(57) ABSTRACT

A distributed method for collision-free Beacon-enabled multi-hop IEEE 802.15.4 networking is presented. The method is compatible with the IEEE 802.15.4 standard. It can support a collision-free cluster-tree network for N-to-one data gathering applications or peer-to-peer applications. The beacon schedule and superframe structure arrangement are distributed, which are decided by each device itself based on the GTS allocated by its parent.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

The present invention relates to transmitting/receiving systems and methods and more specifically, to synchronized wireless networks compatible with IEEE 802.15.4 standard.

2. Description of the Related Art

The IEEE 802.15.4 standard was defined in 2003 for use in Low Rate Wireless Personal Area Networks (LR-PANs). The standard specifies the Medium Access Control (MAC) and Physical Layers but does not include a routing protocol. The standard has been used extensively to enable wireless communication between small battery-powered devices.

Multi-hop 802.15.4 networks are based on an interconnected star topology. The centre of each star is a Coordinator that has 1-hop connectivity to a number of children, either leaf nodes or neighbouring Coordinators, and at least one parent, a neighbouring Coordinator. The network root is referred to as a Personal Area Network Coordinator (PANC). All nodes are either Full Function Devices (FFDs) or Reduced Function Devices (RFDs). FFDs implement the full stack and can be Coordinators or leaf nodes. RFDs only have limited functionality and can only act as leaf nodes.

The 802.15.4 protocol supports two operational modes: beacon-less and beacon-enabled. In beacon-enabled mode, a superframe structure is used to manage communication between the Coordinator and its associated devices. The format of the superframe is defined by the Coordinator and is broadcast periodically to the other devices. A beacon frame is transmitted at the start of the frame to synchronize devices. The superframe is divided into an Active Period containing 16 equal slots followed by an Inactive Period. The 16 slots are themselves divided into a Contention Access Period (CAP) and an optional Contention Free Period (CFP). During the CAP, devices communicate using CSMA/CA. During the CFP, up to 7 GTS can be allocated to up to 7 devices, as Guaranteed Time Slots (GTS). During each GTS, only the allocated device may communicate. During the inactive period the Coordinator may switch to a low power sleep mode in order to save energy.

A well-known problem with using beacon-enabled mode in multi-hop networks is the uncoordinated activity of nearby stars. Since stars are uncoordinated, packets send by nodes in different stars can collide. This is particularly damaging for beacon frames and GTS transmissions since they do not use CSMA/CA mechanisms. A number of previous works have addressed this problem. However, these solutions are either not compatible with the standard or are centralized, that is, require a central controller.

Two general approaches have been proposed previously for providing collision-free, beacon-enabled, multi-hop IEEE 802.15.4 networks. They are Time Division approach and Beacon-Only Period approach originally provided by Task Group 15.4b.

In the Time Division approach, the active period (or Superframe Duration) of each Coordinator is set to be within the inactive period of all other Coordinators. This is achieved by offsetting each Coordinator's beacon frame relative to that of the PAN Coordinator, such that there is no overlap between any two devices' active period. Usually the Time Division approaches are centralized.

In the Beacon-Only Period (BOP) approach, a time window at the beginning of each PAN Coordinator superframe is reserved for sequential transmission of the beacon frames of all devices in a contention-free fashion. Each Coordinator chooses a beacon offset by selecting a Contention-Free Time Slot (CFTS) such that its beacon frame does not collide with the beacon frames of its neighbors. The BOP approach is not compatible with the IEEE 802.15.4 standard.

### BRIEF SUMMARY OF THE INVENTION

The main object of the invention is to provide a distributed method supporting a collision-free cluster-tree network compatible with the IEEE 802.15.4 standard.

The beacon schedule and superframe structure arrangement are distributed, which are decided by each device itself based on its GTS allocated by its parent.

Device R is the root device of the cluster-tree network, which firstly implements the method as a parent device (device D). Descendant node of device R (device C) associates with the network and request a GTS from its parent (device D). After being allocated with GTS, device C defines its own superframe structure based on its GTS allocated by its parent.

In such a way, any descendant node of device R defines its own superframe structure with Superframe Duration (SD) of device C not overlapping with SD of any other descendants of device R except device C's parent (device D) if SD of device C is inside device C's GTS allocated by device D. Thus a collision-free cluster-tree network is constructed. Collision-free transmission for N-to-one data gathering applications or peer-to-peer applications is supported by the method.

### BRIEF DESCRIPTION OF THE DRAWINGS

The present invention will become more understandable from the detailed description given herein below and the accompanying drawing which is given by way of illustration only, and thus are not limitative of the present invention. In the following figure,

FIG. 1 is a diagram showing the superframe structures defined by device R, D and C, where BI of device C is the same as the BI of device R and D.

FIG. 2 is a diagram showing the superframe structures defined by device R, D and C, where BI of device C is smaller than BI of device R or D.

FIG. 3 is a diagram showing the superframe structures defined by device R, D and C, where BI of device C is larger than BI of device R or D.

### DETAILED DESCRIPTION OF THE INVENTION

The Method to Avoid Collision in Synchronised Wireless Networks compatible with IEEE 802.15.4 standard builds a collision-free cluster-tree network using the following steps.

1. The cluster-head device D broadcasts beacons frames periodically according to the superframe structure defined by device D.

2. When a device C detects the beacon frame it can associate with device D becoming a child node with device D as its parent. The child node (device C) may apply for GTS(s) allocation for transmitting to or receiving from the parent node (device D).

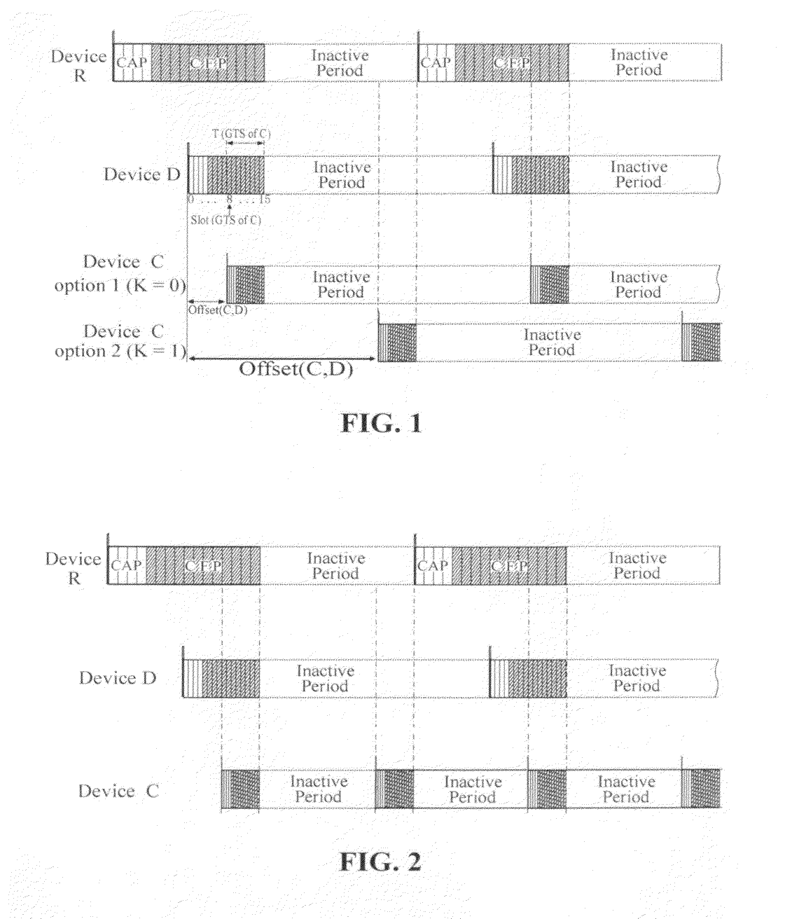

3. When device C is allocated with GTS from its parent device D, it defines its own superframe structure with an offset time Offset(C, D) to device D's superframe structure, and broadcasts its own beacon frames periodically. The Superframe Duration (SD) defined by device C (SD of device C) is no more than T(GTS of C), wherein T(GTS of C) is the time duration of device C's GTS allocated by device D as shown in FIG. 1. SD of device C is no more than T(GTS of C).

4. Device C then will act as a parent device (device D), and other device may associate with it becoming a child node (device C). Therefore steps 1 to 3 can be repeated to construct a multi hop cluster-tree network if each device is associated with no more than one parent device.

Offset(C, D) is a positive time duration between Slot (GTS of C)/16*(SD of device D)+K*(SD of device R) and Slot (GTS of C)/16*(SD of device D)+K*(BI of device C)+[T(GTS of C)−(SD of device C)], wherein Slot (GTS of C) is the time slot number of device C's first GTS slot inside device D's superframe as shown in FIG. 1. K is an integer between 0 and (BI of device D)/(SD of device R)−1, wherein BI of device D is no less than SD of device R, wherein R is the ancestor of device C. Device R is the root node of a cluster-tree topology, wherein the cluster-tree topology can include the whole or a sub-network of the IEEE 802.15.4 compatible network.

The above procedure (steps 1, 2 and 3) was firstly implemented on device R as the first parent device (device D). This procedure can be repeated until T(GTS of C) is less than Superframe Duration (SD) for Superframe Order (SO)=0 according to IEEE 802.15.4 standard, such that device C cannot define its own superframe structure with the shortest SD, because SD of device C is no more than T(GTS of C) according to the above step 3. Device R is not changed when the procedure (steps 1, 2 and 3) is repeated.

Device C's Beacon Interval (BI) can be the same or different from device D or R's BI, as shown in FIGS. 1, 2 and 3.

FIG. 1 shows the superframe structures defined by device R, D and C where BI of device C is the same as the BI of device R and D. The Superframe Duration (SD) defined by device C (SD of device C) is no more than T(GTS of C), wherein T(GTS of C) is the time duration of device C's GTS allocated by device D as shown in FIG. 1. The superframe structure defined by device C with option 1 (K=0) shows SD of device C is inside T(GTS of C). Therefore communication inside SD of device C between device C and C's descendants is collision-free from communication between another child of device D (device C1) and C1's descendants, if device C1's SD is also inside T(GTS of C1). Similarly, the superframe structure defined by device C with option 2 (K=1) (as shown in FIG. 1) provides similar collision-free communication for device C and its descendants. Since device D's BI=Q*(SD of device D), wherein Q=(BI of device D)/(SD of device D). Therefore device D's BI can be divided into Q durations each equals SD of D. Inside each of the Q durations having the same length as SD of device D, there is a period correspondent to T(GTS of C), saying T_{q}(GTS of C) wherein q is an integer between 0 and Q−1. Therefore device C defines its own superframe structure with its SD not overlapped with any other child of device D, as far as SD of device C is inside T_{q}(GTS of C) for any q between 0 and Q−1.

Device R is the first device to implement step 1, 2 and 3, which acts as the parent device D. If device R is not associated with any parent device, its superframe structure is defined by its network layer or upper layer. All the other devices implementing these steps are descendant of device R. Therefore any descendant of device R (device C) defines its own superframe structure with SD of device C not overlapping with SD of any other descendants of device R except device C's parent (device D). If device C defines its own superframe structure with its SD inside T_{K}(GTS of C) for any K between 0 and (BI of device D)/(SD of device R), then SD of device C is not overlapped with SD of any other descendant of device R except device C's parent (device D).

Because device C's SD is overlapped with device D's SD if SD of device C is inside its GTS allocated by device D when K=0 (FIG. 1), therefore collision exists when device C communicates with device D inside the GTS, and device C communicates with its child at the same time. To avoid such collision, device C can reserve GTS inside its SD, such that it can communicate with device D during the reserved GTS without collision with device C's children. If the collision inside the overlapped period between SDs defined by device C and its parent device D, then a cluster-tree based collision-free network rooted from device R is constructed. Inside such a network, beacon broadcasting and GTS communication from device R or any descendant of device R are collision-free.

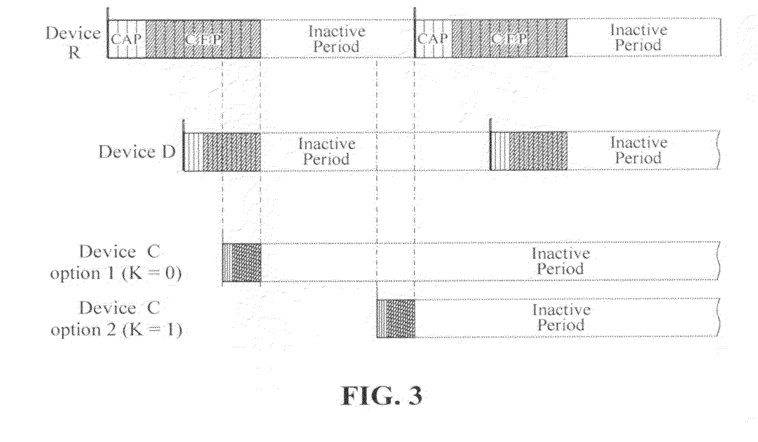

FIGS. 2 and 3 show similar superframe structures defined by device R, D and C. In FIG. 2, BI of device C is smaller than BI of device R and D. In FIG. 3, BI of device C is larger than BI of device R and D.

FIGS. 1, 2 and 3 also show that, when BI of device C is smaller than SD of device R, Offset(C, D) has only one option with K=0 as shown in FIG. 2. When BI of device C is larger than SD of device R, Offset(C, D) has more than one option as shown in FIGS. 1 and 3.

The network association procedure of the method simply follows that of the standard IEEE 802.15.4 beacon-enabled mode. After association, device C sends a GTS allocation request to its parent (device D) to request the allocation of a new GTS(s). Once a child node is allocated with a GTS successfully, it broadcasts its own beacon frame as described above.

In the case that a device leaves the network due to node failure or other reason, the unused GTS is reserved by the parent such that other children's GTSs are not affected. If one of these child nodes requests a new GTS, then the reserved GTS can be allocated again. According to the 802.15.4 standard, a parent node cannot reserve a GTS in this way. If a GTS is de-allocated then the CFP length should be reduced accordingly. However, this change is compatible with the standard, in that it has no effect on the behaviours of child nodes.

Collision-free transmission for data gathering applications (N-to-one communication) can be achieved using the method. At the beginning of device C's GTS, it simply sends its packet to its parent (device D) without collision. The parent (device D) receives the packet, forwards it to its parent during its reserved GTS and so on until the packet reaches device R.

Collision-free peer-to-peer communication is also supported by the method. Peer-to-peer routing is based on nodes assessing whether the packet destination is a descendent in the routing tree or not. If the destination is a descendent of device C, then device C sends the packet to the appropriate child and so on until it finally reaches its destination, otherwise the packet is sent to device C's parent (device D). Uplink traffic is collision free using GTS. Downlink is also collision free if no command packets are transmitted, because all uplink traffic takes place in the GTS and the CAP is dedicated for downlink traffic and command packet transmission. There is no command transmission after the network is setup and the GTSs are allocated. Hence the CAP is collision free for downlink traffic sent by a single parent node to its children.

Spatial reuse can be performed between different cluster-tree topologies rooted from different devices Rᵢ and Rⱼ inside the same network, if radio communications inside different cluster-trees are not interfered.

In summary, the invention is compatible with the IEEE 802.15.4 standard. It can support a collision-free cluster-tree network for N-to-one data gathering applications or peer-to-peer applications. The beacon schedule and superframe structure arrangement are distributed, which are decided by each device itself based on the GTS allocated by its parent.

1. A method of communication to avoid collision in a single hop or multi-hop communication network compatible with IEEE 802.15.4 Media Access Control (MAC) layer protocol, the method comprising the steps of: providing at least one parent device having a transceiver operable to receive and send messages using radio frequency, wherein each parent device defines at least one superframe structure composing a Contention Access Period (CAP) and an optional Contention Free Period (CFP); providing a number of children devices each having a transceiver operable to receive and send messages using radio frequency, wherein each of the children devices is associated with at least one parent device, wherein a child device C can define its own superframe structure with an offset time Offset(C, D) to its parent device D's superframe structure according to device C's GTS allocated by device D, and becomes a parent device of other devices after device C is allocated with at least one Guaranteed Time Slot (GTS) by device D.

2. The method of claim 1 wherein Superframe Duration (SD) of at least one superframe structure defined by device C (SD of device C) is no more than T(GTS of C), wherein T(GTS of C) is the time duration of device C's GTS allocated by device D.

3. The method of claim 1 wherein Beacon Interval (BI) of at least one superframe structure defined by device C (BI of device C) is no less than SD defined by device R, wherein device R is the ancestor of device C.

4. The method of claim 1 wherein Offset(C, D) is the offset time between a superframe defined by device D (SFD) and the closest superframe defined by device C inside or after SFD, wherein Offset(C, D) is a positive value between Slot (GTS of C)/16*(SD of device D)+K*(SD of device R) and Slot (GTS of C)/16*(SD of device D)+K*(BI of device C)+[T(GTS of C)−(SD of device C)], wherein Slot (GTS of C) is the time slot number of device C's first GTS slot inside device D's superframe, K is an integer between 0 and (BI of device D)/(SD of device R)−1, wherein BI of device D is no lees than SD of device R.
